(19) United States
(12) Patent Application Publication
(10) Pub. No.: US 2007/0236128 A1
(43) Pub. Date: Oct. 11, 2007

(54) Device for Fixing an Internal Magnetic Screen to a Frame

(75) Inventor: Pedro Cosma, Roma (IT)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: THOMSON LICENSING S.A., Boulogne (FR)

(21) Appl. No.: 10/569,674

(22) PCT Filed: Aug. 12, 2004
(86) PCT No.: PCT/FR04/50383

§ 371 Date: Sep. 25, 2006

(30) Foreign Application Priority Data
Aug. 29, 2003 (IT) MI2003 A 001685

(51) Int. Cl. H01J 29/06

(52) U.S. Cl. 313/364

(57) ABSTRACT

Cathode ray comprising an internal magnetic screen and a frame designed to support a shadow mask. The screen is attached to the frame by tabs cut from the peripheral lip of the screen, tabs being inserted into openings made in the surface of the flange of the frame coming into contact with the screen. This type of fastening enables the additional parts to be eliminated and the attachment of the screen to the frame to be automated.

The present invention relates to a colour cathode ray tube with a noticeably flat screen, and more specifically a colour selection frame/mask assembly equipping such a tube.

The invention finds its application in any type of tube comprising a colour selection mask and is moreover adapted for tubes with a mask that is realised by stamping as well as for tubes with a mask that is maintained in tension within the tube by a rigid frame to which it is joined.

A conventional cathode ray tube comprises a glass envelope under vacuum. Within the envelope, the tube comprises a colour selection mask located at a precise distance from the glass front face of the tube, front face on which red, green and blue luminophore networks are laid to form a luminescent screen. An electron gun is arranged within the rear part of the tube according to the direction of the longitudinal axis of the tube, the said axis passing through the centre of the front face, the said gun generating three electronic beams in the direction of the said front face. An electromagnetic deflection device, generally located outside the tube and close to the electron gun has the function of deviating the electronic beams so as to sweep them over the surface of the panel on which the luminophore networks are arranged. Under the influence of three electronic beams each corresponding to a determined primary colour, the luminophore networks enable colour pictures to be reproduced on the screen, the mask enabling each determined beam to illuminate only the luminophore of the corresponding colour.

The colour selection mask must be arranged and maintained in a specific position within the tube during the operation of the tube. The mask support functions are realised owing to a generally very rigid rectangular metal frame on which the mask is conventionally welded.

The frame/mask assembly is mounted in the front face using suspension means welded on the frame and co-operating with lugs inserted into the glass constituting the front face of the tube.

The tubes are subject to the influence of components of the earth's magnetic field, which can affect the trajectories of the electron beams emitted by the electron gun. This influence can be strong, depending on the orientation of the tube, and even cause a decolouration in the pictures reproduced on the screen, the electronic beams being deviated from their initial trajectory by the earth's magnetic field and thus illuminating the luminophores that do not correspond to them.

To prevent this phenomenon, it is standard practice to use a magnetic screen, in steel or moly permalloy for example, arranged at the rear of the tube, either inside or outside, so as to protect the electronic beams on their trajectory between the gun and the screen.

The internal magnetic screen is more generally arranged within the tube before the sealing stage between the rear section and the front section made of glass. The magnetic screen can be constituted by several metal parts joined to each other and is itself joined to the frame at its most tapered part either permanently for example by welding or using rivets, or in a removable manner by using additional parts such as clips.

The attachment that uses rivets or welding has the disadvantage of not being able to re-use the parts constituting the frame and the screen in the event of a problem related to either of these parts; moreover, the attachment using additional metal parts such as clips is costly in materials and requires labour, this operation being difficult to automate.

On of the purposes of the invention is to enable the magnetic screen to be assembled and disassembled without the use of additional parts.

For this, the cathode ray tube according to the invention comprises:

a first assembly constituting a colour selection device comprising a mask supported by a frame and a second frame constituting an internal magnetic screen

means for attaching the magnetic screen to the frame, characterized in that this means comprises at least one tab integral with one of the first and second assemblies and is intended to be inserted in an opening made in the other assembly.

The invention and its different advantages will be better understood from the following description and drawings, wherein:

FIG. 1 is a cross-section of a cathode ray tube according to the prior art

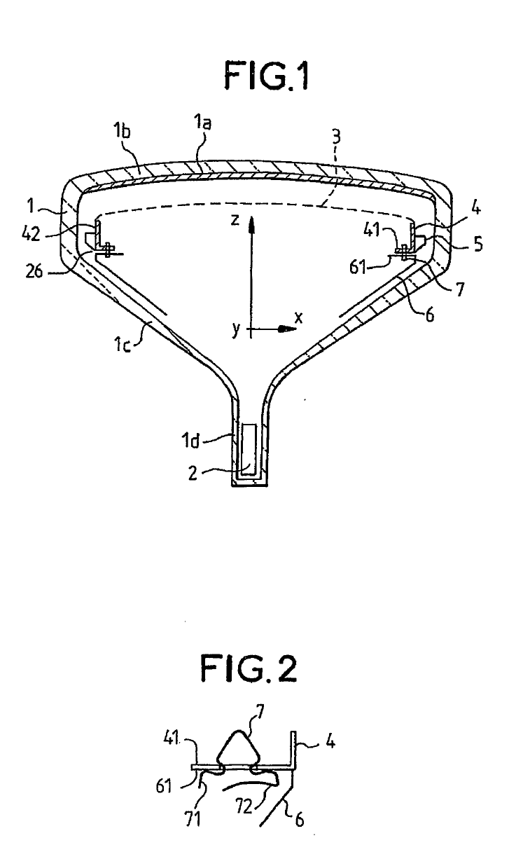

FIG. 2 is a detailed view of the means for attaching the internal magnetic screen to the frame according to the prior art

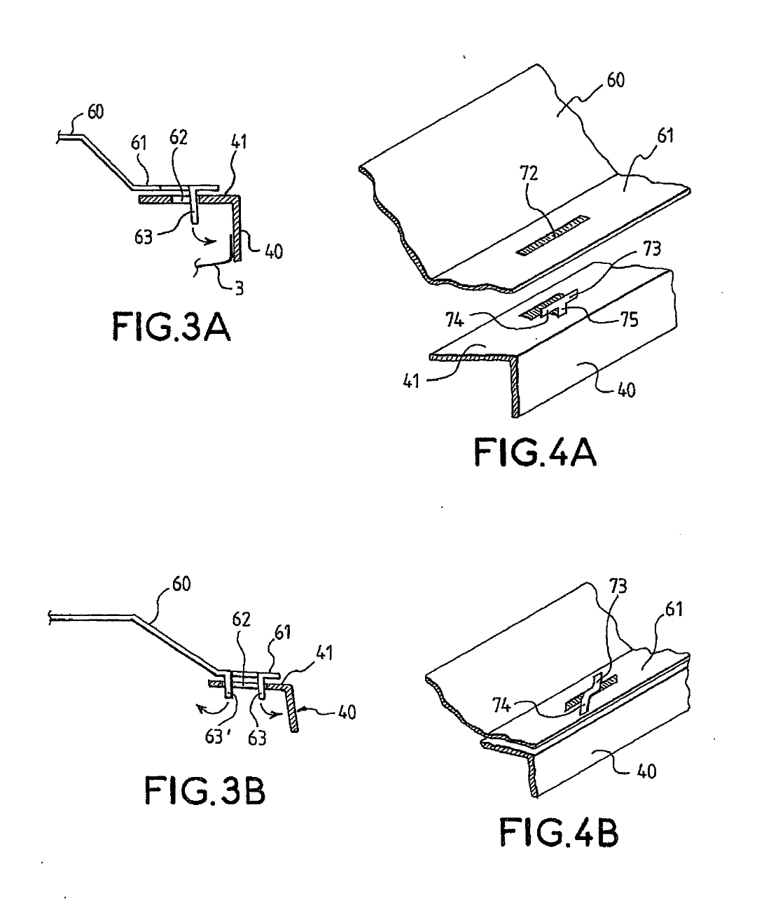

FIGS. 3A and 3B show variants of a first embodiment of the invention

FIGS. 4A and 4B illustrate a second embodiment of the invention

FIG. 1 shows the structure of a colour cathode ray tube by means of a cross-section. Such a tube 1 contains a frame/mask assembly comprising a shadow mask 3 of which the curved surface can be realised by stamping a sheet of steel or invar, a surface that is arranged at a specific distance from a luminophore screen 1a arranged on the glass front face 1b of the tube; the mask is held in place by a rigid frame 4 to which it is joined by welding at the level of its peripheral flange which is folded so as to extend within the frame in a direction noticeably parallel to the longitudinal axis Z. The frame itself is rectangular in shape with the sides at least partly in an L-shaped cross-section, with a flank 42 extending in a direction parallel to the longitudinal axis and a flange 41 noticeably perpendicular to this flank; the flange 41 and the flank are connected to each other at the level of the inner edge 26 of the flank 42 the furthest from the screen.

The tube comprises a rear part in the form of a funnel 1c terminating in a cylindrical collar 1d within which there is an electron gun 2 generating three electronic beams in the direction of the colour selection mask 3. The electronic beams sweep the surface of the screen 1a under the influence of a magnetic deflection device not shown arranged around the rear part 1c.

A magnetic screen 6 is arranged behind the frame/mask assembly so as to protect the trajectories of the beams coming from the gun 2 from the influence of the components of the earth's magnetic field. The screen terminates on the most tapered part with a lip 61 pressing against the flange 41.

FIG. 2 illustrates an example of a means for attaching the screen to the frame. The flanges 41 and the lip 61 have openings designed to be positioned opposite each other. Attachment springs 7 cross the openings of the screen and the mask such that their folded extremities 71 and 72 hold the lip of the screen against the flange of the frame by a spring effect.

This method of attachment is costly, several springs of this type having to be arranged on the periphery of the screen, and their installation requires the intervention of an operator taking into account their arrangement that is difficult to reach.

In an embodiment illustrated by the FIG. 3A, the magnetic screen according to the invention 60 comprises, on the noticeably rectangular peripheral lip 61, at least one cut out part intended to form a tab 63 that has a noticeably rectangular shape, the part not being completely cut out such that the tab remains integral with the peripheral lip. The tab 63 is folded in such a manner as to be perpendicular to the surface of the lip and to be able to be introduced into an opening 62 made in the side of the frame 40 arranged in coincidence with the tab. When the tab is introduced into the opening 62, it is folded in such a manner as to join the screen to the frame.

In the embodiment illustrated by FIG. 3B two tabs 63 and 63′ are cut out in such a manner that their free extremity is opposite. These two tabs folded at 90° with respect to the surface of the lip 61 of the screen are introduced into the opening 62 arranged in coincidence with the flange 41 of the frame; the tabs are then folded opposite each other toward the magnetic screen so as to hold it against the frame. This device offers a better support than a single tab.

In an embodiment illustrated by FIG. 4A, the support tab is cut from the surface of the flange 41 of the frame 40. Here, the tab has a shape such that the free extremity 74 is wider with respect to its base 75 linking it with the surface of the frame; the tab thus has for example a shape of a T, the free extremity of the tab being the upper bar of the T. The tab is folded so as to be noticeably perpendicular to the surface of the frame and enables its insertion into an opening of a slot shape 72 made in the surface of the lip 61 of the magnetic screen. The extremity 74 of the tab is then pivoted about its base 75 so as to lock the lip 61 into position on the frame 40, as shown in FIG. 4B. The thickness of the material constituting the flange of the frame endows this fastener with sufficient rigidity to hold the screen definitively in place on the surface of the flange.

It is possible to preferentially arrange at least one fastening system according to the invention on each of the four sides of the frame/magnetic screen assemblies.

The examples described herein are not restrictive, the tab can either be part of the frame or part of the internal magnetic screen.

Besides the fact that this device for fastening the screen to the frame is economical owing to the suppression of additional linking parts, it is easily possible to automate this fastening as there is only the folding of the tab to be carried out, an operation that can easily be performed by a robot.

1/ Cathode ray tube comprising:
a first assembly constituting a colour selection device comprising a mask supported by a noticeably rectangular frame and a second frame constituting an internal magnetic screen
means for attaching the magnetic screen to the sides of the frame, wherein this means comprises at least one tab integral with one of the first and second assemblies and is intended to be inserted in an opening made in the other assembly.

2/ Cathode ray tube according to claim 1, wherein the tab is cut out from the peripheral lip of the magnetic screen coming into contact with the frame.

3/ Cathode ray tube according to claim 1, wherein the attachment means comprise at least two tabs designed to be inserted into the same opening.

4/ Cathode ray tube according to claim 1, characterized in that wherein the tab has a free extremity wider than its base.

5/ Cathode ray tube according to claim 1, wherein the tab is cut out from the surface of the flange of the frame coming into contact with the magnetic screen.

6/ Cathode ray tube wherein the magnetic screen is attached to each side of the frame by means compliant with claim 1.
